(19) United States
(12) Patent Application Publication
(10) Pub. No.: US 2014/0343723 A1
(43) Pub. Date: Nov. 20, 2014

(54) ELECTRIC MOVER FOR SWING AWAY CONVEYOR

(71) Applicant: Brandt Agricultural Products Ltd., Regina (CA)

(72) Inventors: Ian Meier, Regina (CA); Michael Lockerbie, Regina (CA); Cameron Bodie, Regina (CA); Jack Chappell, Regina (CA); Lyndon Graff, Regina (CA)

(73) Assignee: BRANDT AGRICULTURAL PRODUCTS LTD., Regina (CA)

(21) Appl. No.: 14/045,358

(22) Filed: Oct. 3, 2013

(30) Foreign Application Priority Data
May 17, 2013 (CA) 2816212

(51) Int. Cl. B65G 43/00

(52) U.S. Cl. CPC B65G 43/00
USPC 700/230

(57) ABSTRACT

An electric drive apparatus for attachment to a swing away auger assembly includes a bracket and drive wheel adapted to be attached to the assembly and configured to pivot an attached swing auger. An electric drive motor rotates the drive wheel, and a control circuit assembly is connected to the electric drive motor by drive wires. The control circuit assembly is operative to activate the electric drive motor in response to forward, stop, and reverse drive signals received from a remote control unit. The control circuit is mounted to a heat sink plate such that heat generated in the control circuit assembly is conducted to the heat sink plate, and the heat sink plate forms an external wall of a circuit housing enclosing the control circuit assembly. The circuit housing is sealed. A bin spill prevention system has a sensor that shuts a discharge gate directing material into the conveyor.

This disclosure relates to the field of agricultural implements and in particular conveyors for moving agricultural products.

### BACKGROUND

In the agricultural industry, granular products such as crop seeds, fertilizer, and the like are commonly moved from transport to storage, and vice versa, by belt and auger conveyors powered by an attached tractor. In a typical operation the conveyors are inclined to receive products at the lower end, such as from a truck, and carry them to an elevated location, such as a bin fill opening.

One popular type of conveyor includes a short intake conveyor, commonly called a swing away auger, at the lower end that is pivotally attached at an inner end thereof to the bottom intake end of a main conveyor. A hopper on the outer end of the swing away auger receives product from a truck and transfers same to the intake of the main conveyor. The pivotal attachment allows the hopper to be moved under the discharge chute of a trailer carrying agricultural products.

Remote control powered movement of the hopper allows a truck operator to move the hopper in and out without leaving the truck. Such remote and powered swing away augers are described for example in U.S. Pat. No. 7,191,889 to Heley, U.S. Pat. No. 7,708,131 to Muth, and U.S. Pat. No. 8,272,493 to Grengs. These remote powered systems use an electric motor because the required power is available without starting the tractor, in contrast to a hydraulic motor which requires that the tractor be running to provide hydraulic power. Electric motors and the circuits controlling them are prone to problems with moisture, overheating, and the like, and so dependability of these systems is problematic.

### SUMMARY OF THE INVENTION

The present disclosure provides an electric drive apparatus for a swing away auger that overcomes problems in the prior art.

In a first embodiment the present disclosure provides an electric drive apparatus for attachment to a swing away auger assembly, where the swing away auger assembly comprises a swing auger pivotally connected at an upper discharge end thereof to a lower intake end of a main conveyor about a substantially vertical swing axis, and a hopper mounted to a lower intake end of the swing auger. The electric drive apparatus comprises a bracket assembly adapted to be attached to the swing away auger assembly, and a drive wheel mounted to the bracket, the bracket assembly and drive wheel configured to pivot an attached swing auger about the swing axis. An electric drive motor is connected to rotate the drive wheel, and a control circuit assembly is adapted to be connected to an electrical power source and is connected to the electric drive motor by drive wires. The control circuit assembly is operative to activate the electric drive motor in response to forward, stop, and reverse drive signals received from a remote control unit. The control circuit is mounted to a heat sink such that heat generated in the control circuit assembly is conducted to the heat sink, and the heat sink forms an external wall of a circuit housing enclosing the control circuit assembly. The circuit housing is sealed.

In a second embodiment the present disclosure provides an auger apparatus comprising a main conveyor, and a swing away auger assembly comprising a swing auger pivotally connected at an upper discharge end thereof to a lower intake end of the main conveyor about a substantially vertical swing axis, and a hopper mounted to a lower intake end of the swing auger. A drive wheel is mounted to the swing away auger assembly such that rotation of the drive wheel pivots the swing auger about the swing axis, and an electric drive motor is connected to rotate the drive wheel. A control circuit assembly is adapted to be connected to an electrical power source and is connected to the electric drive motor by drive wires. The control circuit assembly is operative to activate the electric drive motor in response to forward, stop, and reverse drive signals received from a remote control unit. The control circuit is mounted to a heat sink such that heat generated in the control circuit assembly is conducted to the heat sink. The heat sink forms an external wall of a circuit housing enclosing the control circuit assembly, and the circuit housing is sealed.

In a third embodiment the present disclosure provides a bin level spill prevention system comprising a transport vehicle with a truck discharge gate that is opened to discharge granular material from the vehicle, and a closing mechanism operative to open and close the truck discharge gate. A main conveyor with a lower intake end is configured to receive granular material from the truck discharge gate, and has an upper discharge end. A control circuit assembly is connected by wireless radio signals to the closing mechanism and is operative to selectively open and close the truck discharge gate in response to gate signals received from a control unit. A bin level sensor is attached to the upper discharge end of the main conveyor, and is operative to send wireless radio alarm signals to the control circuit assembly when a bin is full, and the control circuit assembly is operative to activate the closing mechanism to close the truck discharge gate in response to receipt of the alarm signal.

The present disclosure provides an electric drive apparatus for a swing away auger assembly that with a sealed circuit housing that dissipates heat generated by electrical components through a heat sink that forms an external wall of the housing, and thus transfers heat from the interior of the housing to the exterior thereof. The electrical components can be selected to minimize heat generated in the circuit housing as well, using CMOS technology, “soft start” operation, and heavy copper bar conductors.

The present disclosure also provides a bin level spill prevention system which will close off the flow of granular products into the conveyor when the bin is full.

### DESCRIPTION OF THE DRAWINGS

While the invention is claimed in the concluding portions hereof, preferred embodiments are provided in the accompanying detailed description which may be best understood in conjunction with the accompanying diagrams where like parts in each of the several diagrams are labeled with like numbers, and where:

FIG. 1 depicts a schematic perspective view of an exemplary auger apparatus, showing an electric drive apparatus installed thereon;

FIG. 2 depicts a perspective exploded view of a control circuit assembly of the electric drive apparatus of FIG. 1;

FIG. 2A depicts a perspective view of the control circuit assembly of FIG. 2 in an assembled configuration.

FIG. 3 depicts a perspective exploded view of an installation of the control circuit assembly of FIG. 2 in a circuit housing;

FIG. 4 depicts a top plan view of an alternative exemplary heat sink arrangement for use with the control circuit assembly of FIG. 2; and

FIG. 5 depicts a cross sectional view of the heat sink arrangement of FIG. 4 taken along line 5-5 in FIG. 4.

### DETAILED DESCRIPTION OF THE ILLUSTRATED EMBODIMENTS

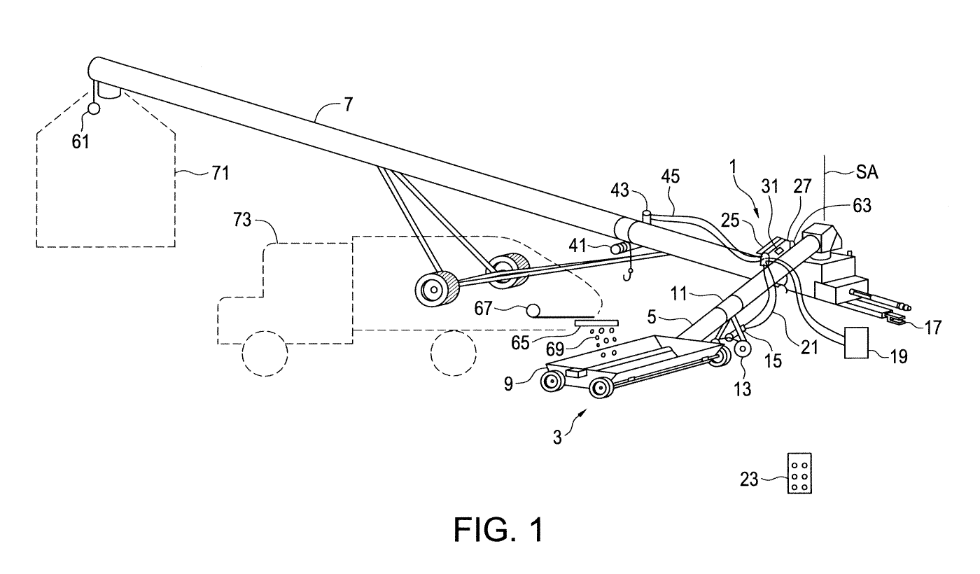

FIG. 1 illustrates an embodiment of an electric drive apparatus 1 of the present disclosure for attachment to a swing away auger assembly 3. The swing away auger assembly 3 comprises a swing auger 5 pivotally connected at an upper discharge end thereof to a lower intake end of a main conveyor 7 about a substantially vertical swing axis SA, and a hopper 9 mounted to a lower intake end of the swing auger 5.

The electric drive apparatus 1 comprises a bracket assembly 11 adapted to be attached to the swing away auger assembly 3, and a drive wheel 13 mounted to the bracket 11. The bracket assembly 11 and drive wheel 13 are configured to pivot an attached swing auger 5 about the swing axis SA as is known in the prior art. The bracket 11 and drive wheel 13 are shown mounted to the swing auger 5, however it is also known to mount a drive wheel or wheels directly to the hopper 9. An electric drive motor 15 is connected to rotate the drive wheel 13. The main conveyor 7 has a hitch 17 at the lower end thereof for connecting to a tractor, the electrical system of which provides an electrical power source 19 to operate the apparatus 1.

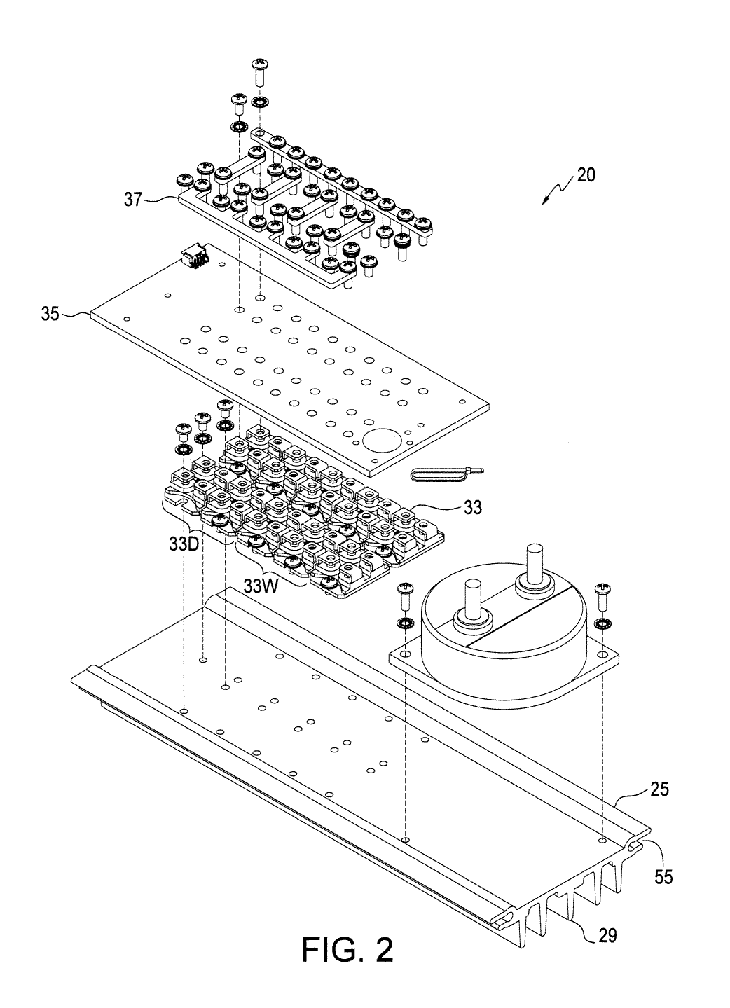

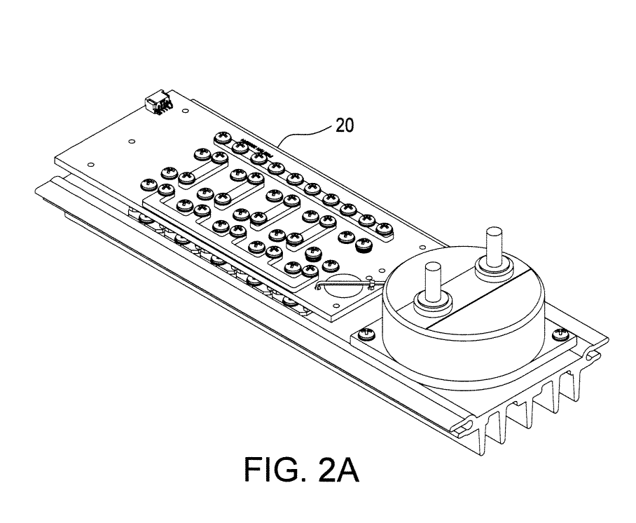

A control circuit assembly 20, as schematically illustrated in FIGS. 2 and 3, is adapted to be connected to the electrical power source 19 and is connected to the electric drive motor 15 by drive wires 21. The control circuit assembly 20 is operative to activate the electric drive motor 15 in response to forward, stop, and reverse drive signals received from a remote control unit 23, and is sealed inside a circuit housing 27.

The control circuit 20 is mounted to a heat sink. In the apparatus 1 the heat sink is provided by a metal plate 25, typically aluminum, and the control circuit 20 is mounted to the plate 25 such that heat generated in the control circuit assembly 20 is conducted to the plate 25. The plate 25 forms an external wall of the circuit housing 27 enclosing the control circuit assembly 20. In the illustrated apparatus 1, the metal plate 25 is provided by an aluminum plate with fins 29 extending from an outer surface thereof and from an outer surface of the circuit housing 27. An alternate heat sink is described below.

The circuit housing 27 is sealed to prevent the entrance of moisture from rain, snow, etc. which is damaging to electrical components. The control circuit assembly 20 generates significant heat, and since the circuit housing must be sealed to prevent moisture intrusion, there is no circulation of cooler outside air, and so the temperature inside the circuit housing can be excessive, and sufficient to damage the components. In the present apparatus 1, heat is transferred from the components to the heat sink plate 25, which has an external surface exposed to the cooler outside air, and dissipated outside the circuit housing 27.

In the illustrated apparatus 1 the circuit housing 27 is adapted to be mounted on the swing auger 5, and a control panel 31 is mounted to the circuit housing 27 and is operative to send signals corresponding to signals sent by the remote control unit 23 so that if the remote control unit is not present, an operator can activate the drive wheel 13 with the control panel. Also since heat rises, the dissipation of heat can be enhanced by mounting the circuit housing 27 such that the heat sink plate 25 is on a side or a top of the circuit housing 27, as schematically illustrated in FIG. 1.

As schematically illustrated in FIGS. 2 and 3, in the illustrated apparatus 1 the control circuit 20 comprises a plurality of metal-oxide-semiconductor field-effect transistors (MOSFETs) 33 fastened on a base side thereof to the heat sink plate 25 such that heat generated in the MOSFETs 33 is readily conducted to the heat sink plate 25.

A circuit board 35 is attached on a first face thereof to a terminal side of the MOSFETs 33 opposite the base side thereof, and connects drive MOSFETs 33D in an H-bridge configuration such that the electric drive motor 15 can be rotated in forward and reverse directions in response to the forward and reverse drive signals received from the remote control unit 23.

The circuit board 35 comprises an array of copper bars 37 on an opposite second face thereof, the array of copper bars conducting electric current from the drive MOSFETs 33D to the electric drive motor 15 through external terminals 39. The copper bars 37 have a solid cross-section that is larger than is possible with wires, providing decreased resistance and thus generating less heat in the sealed circuit housing 27. The copper bars are formed with appropriate connection holes to suit the configuration of the circuit board 35, and thus need not be bent as is the typical case when wires are used.

As a further convenience the illustrated apparatus 1 includes a winch 41 driven by an electric winch motor 43. The control circuit assembly 20 is connected to the electric winch motor 43 by winch wires 45, and the control circuit assembly 20 is operative to activate the electric winch motor 43 in response to up, stop, and down winch signals received from the remote control unit 23 or control panel 31. As with the drive MOSFETs 33D, the circuit board connects winch MOSFETs 33W in an H-bridge configuration such that the electric winch motor 43 can be rotated in up and down directions in response to the up and down winch signals received from the remote control unit 23 or control panel 31. The array of copper bars 37 also conducts electric current from the winch MOSFETs 33W to the electric winch motor 41.

The control circuit assembly 20 further comprises a programmable microprocessor 47 programmed to measure currents in the control circuit assembly 20 and operative to limit current flowing in the control circuit assembly 20 to a selected maximum current to protect the control circuit assembly from damage. For example if swing away auger assembly 3 contacts an obstruction when moving under power of the electric drive motor 15, the motor will try to draw more current as it slows to a stop. When this happens the microprocessor 47 will turn off power to the drive motor 15, preventing damage to the motor 15 and control circuit assembly 20, and allowing the operator to remove the obstruction, and then restart the undamaged drive motor 15 with the undamaged control circuit assembly 20.

The microprocessor 47 is programmed to detect forward and reverse drive signals when the electric drive motor 15 is idle, and is operative to provide a gradually increasing current to the electric drive motor 15 in response. Similarly the microprocessor is programmed to detect a stop drive signal when the electric drive motor 15 is operating in forward or reverse, and is operative to provide a gradually decreasing current to the electric drive motor 15 in response. This “soft start” operation of ramping the current up and down reduces current draw on start-up and reduces the tendency of the hopper to start and stop suddenly, smoothing the movement and reducing stress on the mechanism.

A problem that also occurs when a DC electric motor, like drive motor 15, starts to slow down is that it becomes a generator and “back-drives” current into the control circuit assembly 20, which can damage the components. The “soft start” current ramping reduces back-driven current.

As further protection the microprocessor 47 is programmed to detect a temperature inside the circuit housing 27 and turn off power to the control circuit assembly 20 when a maximum acceptable temperature is detected. Again to reduce heat the programmable microprocessor 47 uses complementary metal-oxide-semiconductor (CMOS) technology which is known to generate reduced heat compared to many other technologies.

FIG. 2 schematically illustrates the assembly of the control circuit assembly 20 and attachment thereof to the heat sink plate 25. FIG. 3 schematically illustrates the assembly of the circuit housing 27. The microprocessor 47 is connected to the fully assembled control circuit assembly 20 and interfaces with the control panel 31 mounted on the housing cover 51. The housing cover 51 includes ribs 53 on each side which slide into grooves 55 in the sides of the heat sink plate 25. A sealant material, such as silicone, is typically placed into the grooves 55 prior to installation of the housing cover 51. End caps 57 are attached to the housing cover 51 and heat sink plate 25 with screws or the like and sealed with o-rings 59. External terminals 39 extend through the end cap 57 for attachment to the drive wires 21, winch wires 45, as well as wires for lights or other ancillary devices, and are sealed to the end cap 57 with sealant.

The apparatus 1 can also conveniently include a bin level sensor 61 adapted to be attached to an upper discharge end of the main conveyor 7, and operative to send wireless radio alarm signals to the control circuit assembly 20 in the circuit enclosure 27 when a bin 71 is full. The control circuit assembly 20 is operative to activate a visual and/or audio alarm 63 in response to receipt of an alarm signal.

It may be desired to provide an truck discharge gate 65 mounted on a transport vehicle 73 with a closing mechanism 67, such as is schematically illustrated in FIG. 1 discharging granular agricultural products 69 into the hopper 9. The closing mechanism 67 can be connected by wireless radio signals to the control circuit assembly 20, and the control circuit assembly 20 operative to activate the closing mechanism 67 to close the truck discharge gate 65 in response to receipt of the alarm signal. With discharge gate 65 closed, the flow of material into the hopper 9 stops but the swing auger 5 and main conveyor 7 continue to run and thus empty the material therein into the bin 71. The bin level sensor 61 is located to provide sufficient room in the bin 71 for the auger 5 and conveyor 7 to be emptied.

For improved dependability of connection between control circuit assembly 20 and the remote control unit, and also the bin level sensor 61 and closing mechanism 67, the remote control unit 23 and control circuit assembly 20 use a frequency in the 2.4 GHz range. For further convenience the remote control unit 23 can be configured to operate up to four different auger systems. Alternatively the remote control unit 23 could be provided by a handheld personal computer or “smart” phone.

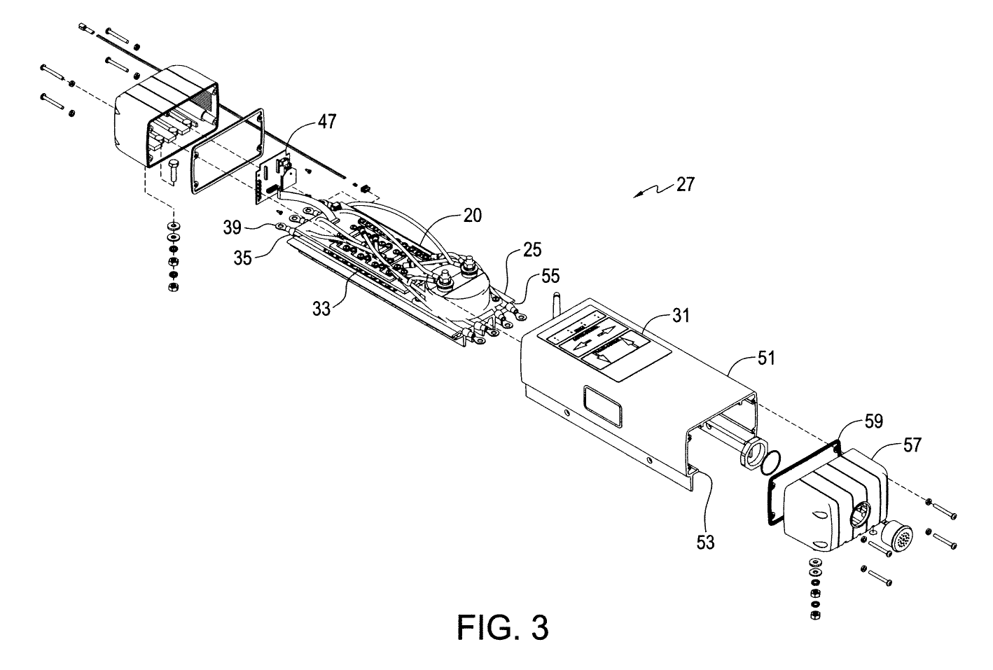

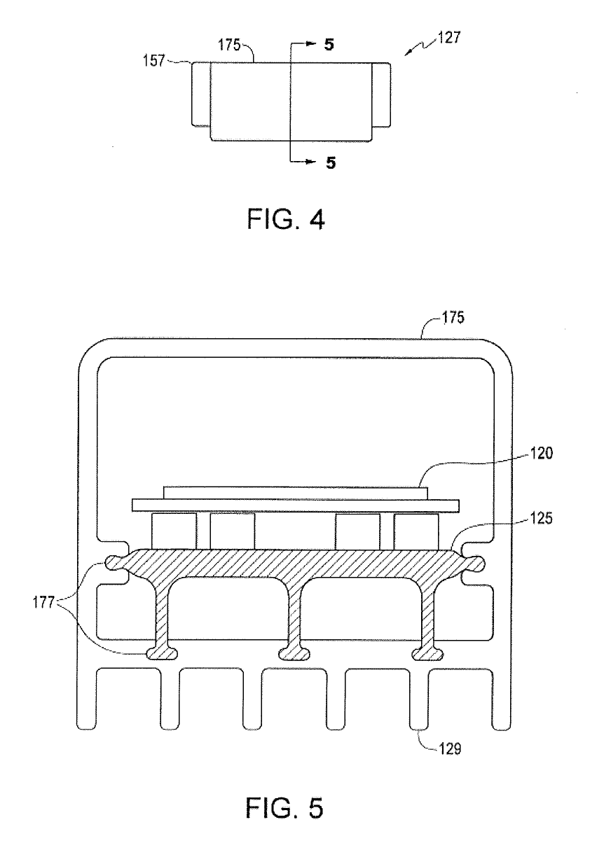

FIGS. 4 and 5 schematically illustrate an alternate heat sink arrangement where the circuit housing 127 is provided by a metal tube 175 with end caps 157 sealed to corresponding ends of the metal tube 175. The heat sink comprises the metal tube 175 and a metal tray 125 engaged in slots 177 on interior walls of the metal tube 175. Typically the tube 175 and tray 125 are made from aluminum which is a good conductor of heat and exterior fins 129 are provided to expedite heat dissipation.

The control circuit assembly 120 is mounted to the metal tray 125 so heat generated in the control circuit assembly 120 is conducted to the tray 125 as in the arrangement above, and that heat is then conducted readily from the tray 125 to the tube 175. The tube 175 has a larger surface area exposed to the cooler ambient air than the plate 25 in the apparatus 1 described above and so dissipates heat to the atmosphere rapidly.

The heat sink of FIGS. 4 and 5 has the advantage of providing a more efficient seal, as only the end caps 157 need to be sealed to the tube 175 to form the sealed circuit housing 127.

The present disclosure thus provides an electric drive apparatus for attachment to a swing away auger assembly with improved dependability and reduced maintenance. Although the electrical components are protected in a sealed circuit housing, heat is drained out of the sealed housing through the heat sink The heat generated inside by operation of the system is also reduced by the use of CMOS technology, heavy copper bar conductors, and a “soft start” current ramping operation.

The present disclosure also provides a bin level spill prevention system which will close off the flow of granular products into the conveyor when the bin is full.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

What is claimed is:

1. An electric drive apparatus for attachment to a swing away auger assembly, where the swing away auger assembly comprises a swing auger pivotally connected at an upper discharge end thereof to a lower intake end of a main conveyor about a substantially vertical swing axis, and a hopper mounted to a lower intake end of the swing auger, the electric drive apparatus comprising:
a bracket assembly adapted to be attached to the swing away auger assembly, and a drive wheel mounted to the bracket, the bracket assembly and drive wheel configured to pivot an attached swing auger about the swing axis;
an electric drive motor connected to rotate the drive wheel;
a control circuit assembly adapted to be connected to an electrical power source and connected to the electric drive motor by drive wires, the control circuit assembly operative to activate the electric drive motor in response to forward, stop, and reverse drive signals received from a remote control unit;
wherein the control circuit assembly is mounted to a heat sink such that heat generated in the control circuit assembly is conducted to the heat sink;
wherein the heat sink forms an external wall of a circuit housing enclosing the control circuit assembly; and
wherein the circuit housing is sealed.

2. The apparatus of claim 1 wherein the heat sink comprises a metal plate and wherein the control circuit assembly is mounted to the metal plate, and the metal plate forms the external wall of the circuit housing.

3. The apparatus of claim 1 wherein the circuit housing is provided by a metal tube with end caps sealed to corresponding ends of the metal tube, and wherein the heat sink comprises the metal tube and a metal tray engaged in slots on interior walls of the metal tube, and wherein the control circuit assembly is mounted to the metal tray.

4. The apparatus of claim 1 wherein the heat sink comprises fins extending from an outer surface of the circuit housing.

5. The apparatus of claim 1 wherein the control circuit comprises a plurality of metal-oxide-semiconductor field-effect transistors (MOSFETs) fastened on a base side thereof to the heat sink plate.

6. The apparatus of claim 5 wherein the control circuit comprises a circuit board attached on a first face thereof to a terminal side of the MOSFETs opposite the base side thereof, the circuit board connecting drive MOSFETs in an H-bridge configuration such that the electric drive motor can be rotated in forward and reverse directions in response to the forward and reverse drive signals received from the remote control unit.

7. The apparatus of claim 6 wherein the circuit board comprises an array of copper bars on an opposite second face thereof, the array of copper bars conducting electric current from the drive MOSFETs to the electric drive motor.

8. The apparatus of claim 6 further comprising a winch driven by an electric winch motor wherein the control circuit assembly is connected to the electric winch motor by winch wires, and wherein the control circuit assembly is operative to activate the electric winch motor in response to up, stop, and down winch signals received from the remote control unit.

9. The apparatus of claim 8 wherein the circuit board connects winch MOSFETs in an H-bridge configuration such that the electric winch motor can be rotated in up and down directions in response to the up and down winch signals received from the remote control unit.

10. The apparatus of claim 9 wherein the circuit board comprises an array of copper bars on an opposite second face thereof, the array of copper bars conducting electric current from the winch MOSFETs to the electric winch motor.

11. The apparatus of claim 1 wherein the control circuit assembly further comprises a programmable microprocessor programmed to measure a current in the control circuit assembly and operative to limit current flowing in the control circuit assembly to a selected maximum current.

12. The apparatus of claim 11 wherein the microprocessor is programmed to detect forward and reverse drive signals when the electric drive motor is idle, and provide a gradually increasing current to the electric drive motor in response.

13. The apparatus of claim 12 wherein the microprocessor is programmed to detect a stop drive signal when the electric drive motor is operating, and provide a gradually decreasing current to the electric drive motor in response.

14. The apparatus of claim 1 further comprising a bin level sensor adapted to be attached to an upper discharge end of the main conveyor, and operative to send wireless radio alarm signals to the control circuit assembly when a bin is full, and wherein the control circuit assembly is operative to activate an alarm in response to receipt of an alarm signal.

15. The apparatus of claim 14 further comprising a truck discharge gate mounted on a transport vehicle with a closing mechanism connected by wireless radio signals to the control circuit assembly, and wherein the control circuit assembly is further operative to activate the closing mechanism to close the truck discharge gate in response to receipt of the alarm signal

16. The apparatus of claim 1 wherein the circuit housing is adapted to be mounted on the swing auger, and a control panel is mounted to the circuit housing operative to send signals corresponding to signals sent by the remote control unit.

17. An auger apparatus comprising:
a main conveyor;
a swing away auger assembly comprising a swing auger pivotally connected at an upper discharge end thereof to a lower intake end of the main conveyor about a substantially vertical swing axis, and a hopper mounted to a lower intake end of the swing auger;
a drive wheel mounted to the swing away auger assembly such that rotation of the drive wheel pivots the swing auger about the swing axis, and an electric drive motor connected to rotate the drive wheel;
a control circuit assembly adapted to be connected to an electrical power source and connected to the electric drive motor by drive wires, the control circuit assembly operative to activate the electric drive motor in response to forward, stop, and reverse drive signals received from a remote control unit;
wherein the control circuit is mounted to a heat sink such that heat generated in the control circuit assembly is conducted to the heat sink plate;
wherein the heat sink forms an external wall of a circuit housing enclosing the control circuit assembly; and
wherein the circuit housing is sealed.

18. The apparatus of claim 17 wherein the heat sink comprises a metal plate and wherein the control circuit assembly is mounted to the metal plate, and the metal plate forms the external wall of the circuit housing.

19. The apparatus of claim 17 wherein the circuit housing is provided by a metal tube with end caps sealed to corresponding ends of the metal tube, and wherein the heat sink comprises the metal tube and a metal tray engaged in slots on interior walls of the metal tube, and wherein the control circuit assembly is mounted to the metal tray.

20. A bin level spill prevention system comprising:
a transport vehicle with a truck discharge gate that is opened to discharge granular material from the vehicle;
a closing mechanism operative to open and close the truck discharge gate;
a main conveyor with a lower intake end configured to receive granular material from the truck discharge gate, and an upper discharge end;
a control circuit assembly connected by wireless radio signals to the closing mechanism and operative to selectively open and close the truck discharge gate in response to gate signals received from a control unit;
a bin level sensor attached to the upper discharge end of the main conveyor, and operative to send wireless radio alarm signals to the control circuit assembly when a bin is full, and wherein the control circuit assembly is operative to activate the closing mechanism to close the truck discharge gate in response to receipt of the alarm signal.

21. The system of claim 20 further comprising a swing away auger assembly, where the swing away auger assembly comprises a swing auger pivotally connected at an upper discharge end thereof to the lower intake end of the main conveyor about a substantially vertical swing axis, and a hopper mounted to a lower intake end of the swing auger.

22. The system of claim 21 comprising an electric drive apparatus operative to pivot the swing auger about the swing axis, and wherein the control circuit assembly is operative to activate the electric drive apparatus in response to drive signals received from the control unit.

23. The system of claim 20 wherein the control circuit assembly is operative to activate an alarm in response to receipt of the alarm signal.

24. The system of claim 20 wherein the control unit is a remote control unit.
